(19) United States
(12) Patent Application Publication
(10) Pub. No.: US 2014/0339060 A1
(43) Pub. Date: Nov. 20, 2014

(54) PUSH-ON-PUSH-OFF BISTABLE SWITCH

(71) Applicant: National Taiwan University, Taipei (TW)

(72) Inventors: Yao-Joe Yang, Taipei (TW); Hen-Wei Huang, Taipei (TW)

(73) Assignee: NATIONAL TAIWAN UNIVERSITY, Taipei (TW)

(21) Appl. No.: 14/080,070

(22) Filed: Nov. 14, 2013

(30) Foreign Application Priority Data
May 20, 2013 (TW) 102117713

(51) Int. Cl. H01H 21/02

(52) U.S. Cl. CPC H01H 21/02
USPC 200/335

(57) ABSTRACT

A push-on-push-off bistable switch is disclosed. The push-on-push-off bistable switch includes an actuator, a lever mechanism connected to the actuator and having a long portion and a short portion, a bistable switch mechanism connected to the short portion, and a displacement amplifier mechanism connected to the long portion, wherein the bistable switch mechanism and the displacement amplifier mechanism are substantially parallel to each other, and the displacement amplifier mechanism has a driving portion and is adjacent to a driven portion of the bistable switch mechanism. The switch of the invention requires only one single actuator and thus can reduce the size of components, increase good throughput, simplify operational complexity and achieve the push-on-push-off switch effect. In addition, the displacement amplifier mechanism and the lever mechanism can magnify efficacy of the actuator to increase the energy saving effect.

### BACKGROUND OF THE INVENTION

1. Field of the Invention

The present invention relates to a bistable switch, and more particularly, to a novel push-on-push-off bistable switch.

2. Description of Related Art

A bistable switch is a major control element in circuitry. Due to the evolution of micro-electro-mechanical systems (MEMS), bistable switches have been widely applied in micro-mechanisms such as a micro-valve, a micro-relay, an RF switch, and an optical switch. The so-called bistable switch typically has two stable states and only requires energy inputs during switching. Once the input energy exceeds the threshold value, the bistable switch would automatically enter a snap through mode, switch from a stable state to the other stable state, and stay in that stable state without further energy inputs. Therefore, a bistable switch can stay in a stable state without any external force applied thereon, and thus has low power consumption and high positioning precision characteristics. Hence, bistable switches become essential applications for microelectromechanical systems.

The conventional bistable switches, for example, bistable switches disclosed in Taiwanese Patent No. 1310953, necessitate the coordination of two sets of actuators in order to accomplish the switch of bistable states. Since the configuration of actuators would occupy a large portion of space in the fabrication of microelectromechanical systems, the use of two sets of actuators would inevitably decrease the efficiency of throughput and yield, but increase complicated controls of bistable switches.

Therefore, it is highly desirable to propose a novel bistable switch capable of overcoming the drawbacks as encountered in prior techniques, by employing only one actuator to achieve the push-on-push-off switch effect, thereby reducing complexities of fabrication and control of the bistable switch and further improving the power consumption characteristics of the actuator.

### SUMMARY OF THE INVENTION

The invention proposes a push-on-push-off bistable switch, including an actuator; a lever mechanism having a long portion and a short portion, wherein the hinge is fixed by the fastening anchor at a connection of the long portion and the short portion, and one of the long potion and the short portion is connected to the actuator; a bistable mechanism having one end connected to the short portion of the lever mechanism and having a first stable state and a second stable state; and a displacement amplifier mechanism having a curving beam with one end thereof being connected to one side of the long portion of the lever mechanism opposing to the actuator, wherein the bistable mechanism and the displacement amplifier mechanism are substantially parallel to each other.

In the push-on-push-off bistable switch, when the bistable mechanism is in the first stable state, the actuator drives the long portion of the lever mechanism to displace so as to push on one end of the displacement amplifier mechanism such that the displacement amplifier mechanism bends toward the bistable mechanism and moves laterally, and at the same time relatively moves the lever mechanism to rotate around the hinge such that the short portion of the lever mechanism pulls an end of the short portion to which the bistable mechanism is connected, and when the lateral displacement of the displacement amplifier mechanism exceeds beyond a gap between the displacement amplifier mechanism and the bistable mechanism, the displacement amplifier mechanism starts to propel and deform the bistable mechanism such that the bistable mechanism switches from the first stable state to the second stable state.

When the bistable mechanism is in the second stable state, the actuator actuates the long portion of the lever mechanism to displace so as to push on one end f the displacement amplifier mechanism such that the displacement amplifier mechanism bends toward the bistable mechanism and move laterally, and at the same time move the lever mechanism to rotate around the hinge such that the short portion of the lever mechanism pulls an end of the short portion to which the bistable mechanism is connected, and the bistable mechanism bends towards the displacement amplifier mechanism and becomes deformed to switch from the second stable state back to the first stable state.

Compared to conventional techniques, the push-on-push-off bistable switch of the invention employs only one single actuator to achieve the push-on-push-off switch effect, thereby reducing the size and operational complexities in the manufacture and control of the bistable switch. Moreover, the displacement amplifier mechanism and the lever mechanism of the present invention can amplify displacement of the actuator to switch stably and efficiently and thus enhance the energy-saving characteristics of the switch.

### BRIEF DESCRIPTION OF THE DRAWINGS

The present invention can be more fully understood by reading the following detailed description of the preferred embodiments, with reference made to the accompanying drawings, wherein:

FIG. 1A is a schematic view of the push-on-push-off bistable switch according to an embodiment of the present invention;

FIGS. 1B and 1C are schematic views showing a first stable state and a second stable state of the push-on-push-off bistable switch according to the present invention;

FIG. 2 is a schematic view of the push-on-push-off bistable switch according to another embodiment of the present invention; and

FIGS. 3A to 3G are schematic views showing operational procedures of the push-on-push-off bistable switch according to an embodiment of the present invention.

### DETAILED DESCRIPTION OF THE PREFERRED EMBODIMENTS

The following illustrative embodiments are provided to illustrate the disclosure of the present invention, these and other advantages and effects can be understood by persons skilled in the art after reading the disclosure of this specification. Note that the structures, proportions, sizes depicted in the accompanying figures merely serve to illustrate the disclosure of the specification to allow for comprehensive reading without a limitation to the implementation or applications of the present invention, and does not constitute any substantial technical meaning.

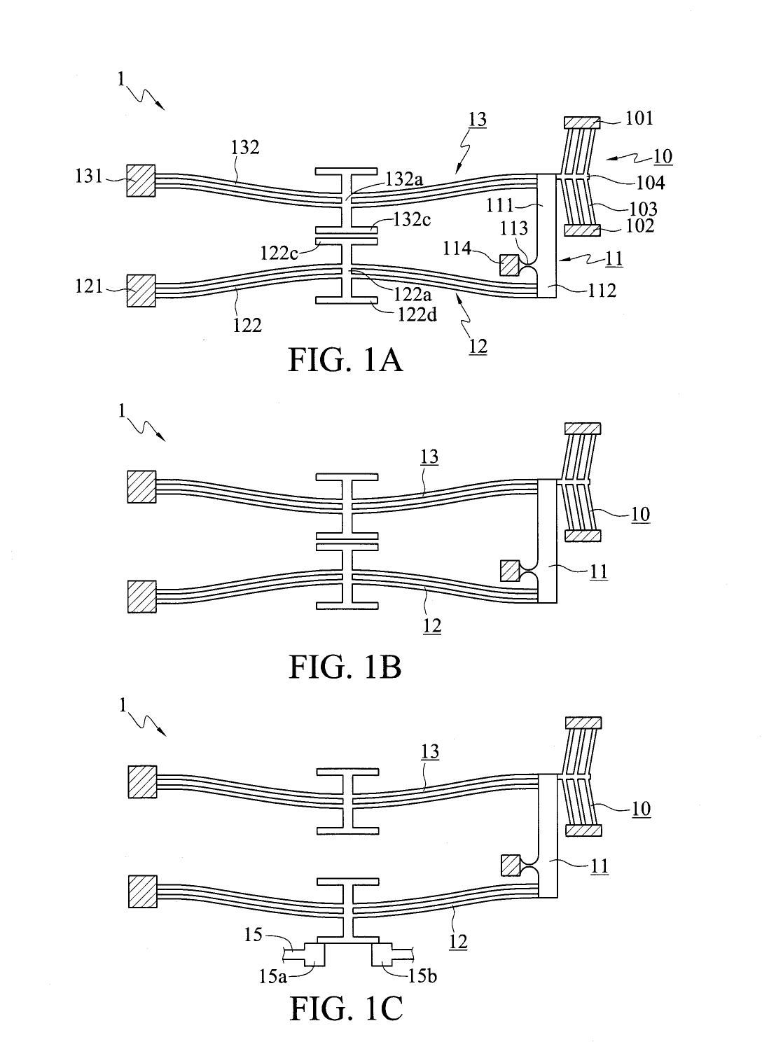

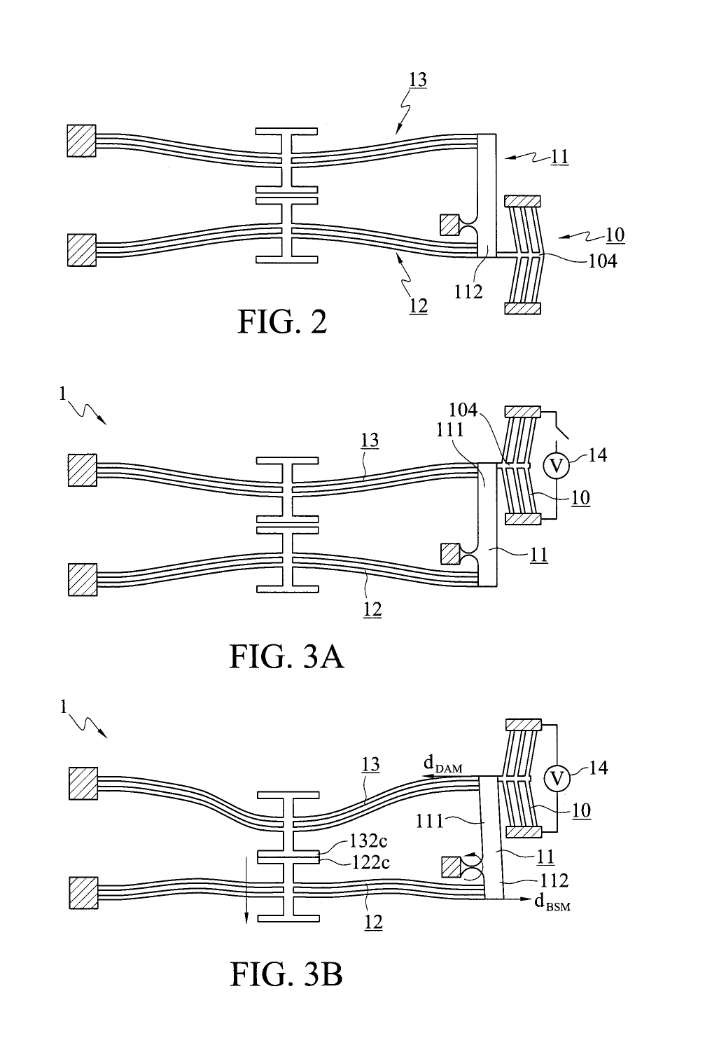

FIG. 1A is a schematic view of the push-on-push-off bistable switch 1, including an actuator 10, a lever mechanism 11, a bistable switch mechanism (BSM) 12, and a displacement amplifier mechanism (DAM) 13.

In this embodiment, the push-on-push-off bistable switch 1 is fabricated by microelectromechanical manufacture techniques, which employ a silicon-on-insulator, SOI, wafer with inductively coupled plasma reactive ion etching (ICP-RIE) manufacture techniques. On the other hand, the manufacture of the push-on-push-off bistable switch of the present invention is not limited to aforementioned techniques, and it could be manufactured by precision mechanic processing, plastic injection, computer numerical control (CNC) processing or any other techniques having the capability of producing similarly like structures.

The actuator 10 may be an electric thermal actuator, a static electric actuator, a piezoelectric actuator, or an electromagnetic actuator. In this embodiment, the push-on-push-off bistable switch further includes a driving power source (not shown) adapted to supply electric power to the actuator 10 to induce deformation.

In this embodiment, the push-on-push-off bistable switch 10 is an electric thermal actuator comprised of first and second anchors 101, 102 and a horizontal beam 103, wherein the horizontal beam 103 comprises a bending portion 104.

In one embodiment, the horizontal beam 103 is constituted by a plurality of parallel V-shaped beams. When an electric voltage is applied to the first and second fastening anchors 101, 102, electric currents flowing through and thus heat up the V-shaped beams to generate thermal deformation, thereby generating unidirectional displacement to enable the bistable mechanism 12 to switch stable states.

In another embodiment, the horizontal beam 103 is constituted by adjacent conductors alternatively having a higher thermal expansion coefficient and a lower thermal expansion coefficient. When an electric voltage is applied to the first and second fastening anchors 101, 102, the V-shaped beams will bend towards the conductor having a higher thermal expansion coefficient.

The lever mechanism 11 is comprised of a long portion 111 and a short portion 112, wherein a hinge 113 is fixed by a fastening anchor 114 at the connection of the long portion 111 and the short portion 112, and the long portion 111 is connected to the bending portion 104 of the actuator 10.

In this embodiment, the bistable mechanism 12 has a third fastening anchor 121 and a first curving beam 122. One end of the first curving beam 122 is connected to the short portion 112 of the lever mechanism while the other end of the first curving beam 122 is connected to the third fastening anchor 121. The bistable mechanism 12 has a first stable state and a second stable state, as illustrated in FIGS. 1B and 1C. Note that the bistable mechanism is not limited to having curving beams as described above, and can include any MEMS structures having the capability of bistable characteristics, such as V-beams bistable mechanisms or chevron-type bistable mechanisms.

In one embodiment, the first curving beam 122 has a first bending portion 122a, and a driven portion 122c extending from the first curving beam 122 is disposed at one end of the first bending portion 122a facing the displacement amplifier mechanism 13.

In another embodiment, the first curving beam 122 of the bistable mechanism 12 is constituted by two parallel beams, and the center portion thereof is clamped by the first bending portion 122a to prevent the first curving beam 122 from rotating or tilting, wherein the shape of the first curving beam 122 is a straight type beam in a bucking mode in axial loading. In another embodiment, the first curving beam can be comprised of a single or more beams to form a bistable mechanism.

In still another embodiment, the driven portion 122c and the conducting portion 122d are truss structures for maintaining and enhancing structural strength.

In still another embodiment, when the bistable mechanism 12 is in the first stable state, the first curving beam 122 bends toward the displacement amplifier mechanism 13, and when the bistable mechanism 12 is in the second stable state, the first curving beam 122 bends away from the displacement amplifier mechanism 13.

In still yet another embodiment, the push-on-push-off bistable switch 1 further comprises a transmission circuit 15 having at least a pair of connecting points 15a, 15b for insulating electrical appliances, so that when the bistable mechanism 12 is in the second stable state, the conducting portion 122d is connected to the connecting points 15a, 15b to electrically conduct the transmission circuit 15.

The displacement amplifier mechanism 13 has a fourth fastening anchor 131 and a curving beam 132. One end of the curving beam 132 is connected to the long portion 111 of the lever mechanism corresponding to one side of the actuator 10, and is substantially parallel to the bistable mechanism 12.

In one embodiment, the curving beam 132 has a bending portion 132a, and a driving portion 132 extending from the curving 132 is disposed at one end of the bending portion 132a facing the bistable mechanism 12, and the end of the driving portion 132 is adjacent to the driven portion 122c.

In another embodiment, the curving beam 132 of the displacement amplifier mechanism 13 is constituted by a single or a plurality of parallel beams, and the center portion thereof is clamped by the first bending portion 132a to prevent the curving beam 132 from rotating or tilting.

In still another embodiment, the driving portion 132c is a truss structure for maintaining and enhancing structural strength.

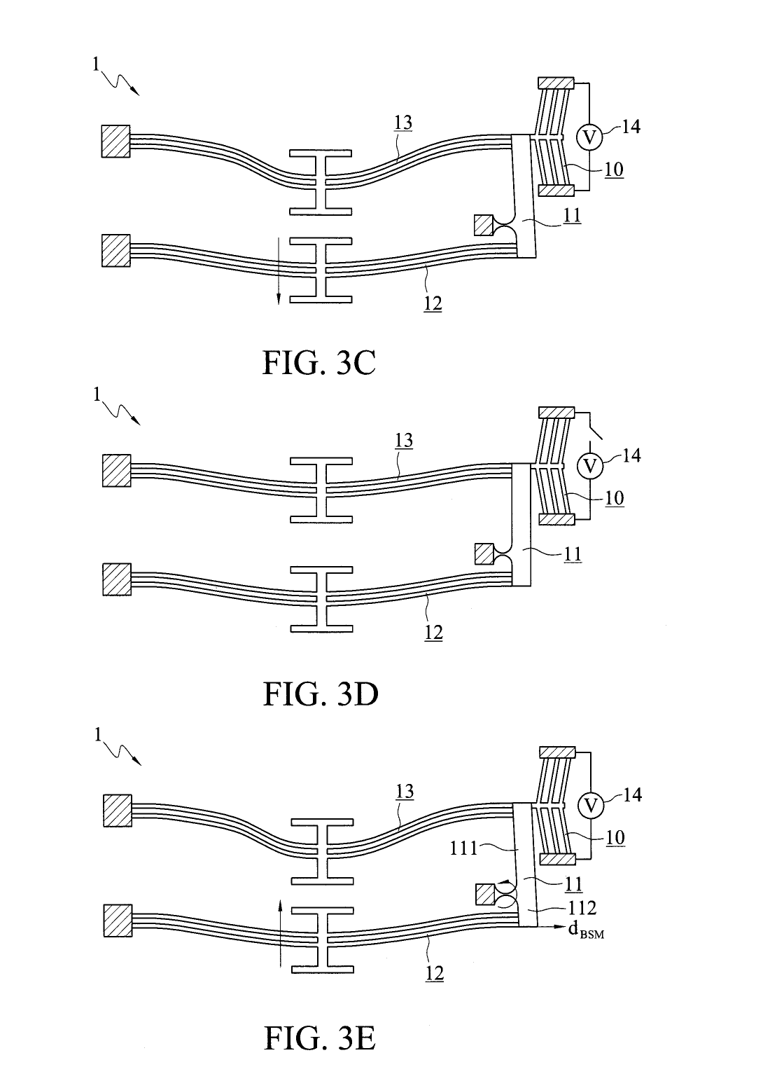

FIG. 2 is a schematic view of the push-on-push-off bistable switch 2, according to a second preferred embodiment of the present invention. The push-on-push-off bistable switch 2 includes an actuator 10, a lever mechanism 11, a bistable switch mechanism (BSM) 12, and a displacement amplifier mechanism (DAM) 13. The characteristics of the first and second embodiments are similar, except that the lever mechanism 11 of this embodiment is connected to the bending portion 104 of the actuator 10 by means of the short portion 112, instead of the long portion 111 as exemplified in the first embodiment. Therefore, similar detailed descriptions of this embodiment will be omitted herein for brevity.

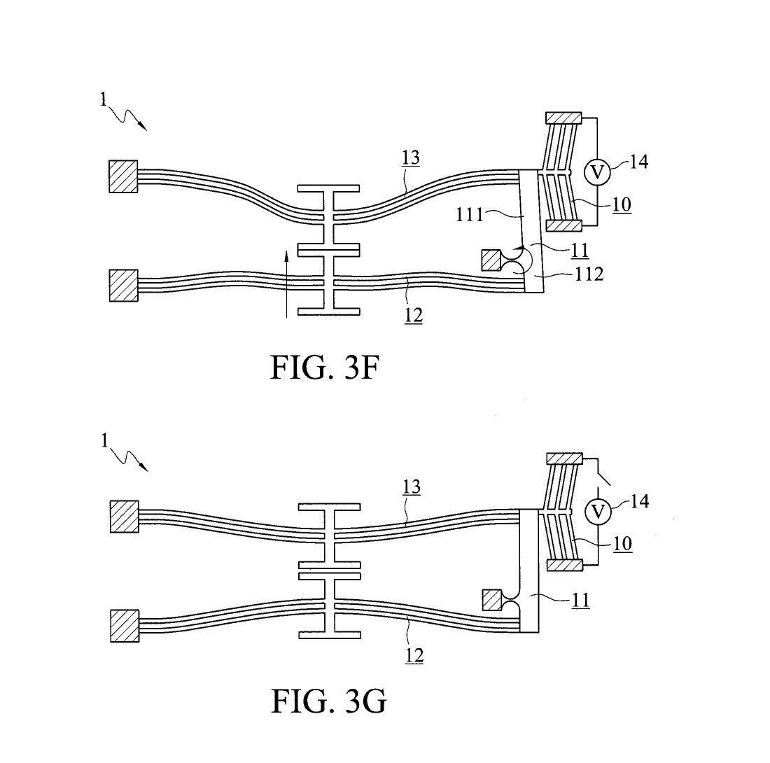

FIGS. 3A to 3G are schematic views showing the push-on-push-off bistable switch according to one embodiment of the present invention. As illustrated in FIG. 3A, the push-on-push-off bistable switch 1 is in an initial state, and the bistable mechanism 12 is in a first stable state.

In FIG. 3B, the power source 14 supplies electric power to the actuator 10 to cause deformation to propel the long portion 111 connected to the bending portion 104, so as to push one end of the displacement amplifier mechanism 13 so that the displacement amplifier mechanism 13 bends toward the bistable mechanism 12 and moves laterally, and at the same time moves the lever mechanism 11 to rotate around the hinge 113. Consequently, the short portion 112 pulls the connecting portion of the bistable mechanism 12 and the short portion 112, as shown in the formula (1) below, thereby decreasing axial rigidity of the bistable mechanism 12 to enable axial rigidity of the displacement amplifier mechanism 13 to increase to an extent far beyond the bistable mechanism 12. When the lateral displacement of the displacement amplifier mechanism 13 is larger than the gap between the displacement amplifier mechanism 13 and the bistable mechanism 12, the driving portion 132c propels the driven portion 122c to deform the bistable mechanism 12.

d_{BSM}=η·d_{DAM}; 0<η<1 (1)

In the formula (1), d_{BSM} is a displacement of a connecting portion of the bistable mechanism 12 and the short portion 112, d_{DAM} is a displacement of a connecting portion of the displacement amplifier mechanism 13 and the long portion 111, η refers to a lever minimizing ratio, i.e. the ratio of the length of the short portion 112 to the length of the long portion 111.

As shown in FIG. 3C, electric power is supplied to the actuator 10 continuously, and when the end of the displacement amplifier mechanism 13 moves beyond a first threshold value d_{DAM-snap}, the lateral displacement of the displacement amplifier mechanism 13 exceeds beyond the first stable state threshold displacement of the bistable mechanism 12, such that the displacement amplifier mechanism 13 has the sufficient output power and output displacement to propel the bistable mechanism 12 to snap and thus switch from the first stable state to the second stable state.

As shown in FIG. 3D, when the voltage applied upon the actuator 10 is removed and after the thermal actuator 10 has cooled off, the displacement amplifier mechanism 13 returns to the initial state and the bistable mechanism 12 maintains in the second stable state.

As depicted in FIG. 3E, when applying the same voltage as that enabling the bistable mechanism 12 to switch from the first stable state to the second stable state upon the actuator 10, the actuator 10 is again heated up to induce deformation that propels the long portion 111 and moves the short portion 112 of the lever mechanism 11 to pull the end of the bistable mechanism 12.

As shown in FIG. 3F, the bistable characteristics of the bistable mechanism 12 become inactive when the end of the bistable mechanism 12 moves to reach a second threshold value d_{BSM-th}, which then causes the bistable mechanism 12 to move towards the first stable state, but since the voltage applied thereupon is not removed, the bistable mechanism 12 is still blocked by the displacement amplifier mechanism 13.

In this embodiment, in the process of switching from the first stable state to the second stable state and recovering from the second stable state to the first stable state, the end of the bistable mechanism 12 is pulled by the short portion 112 to displace. The push-on-push-off bistable switch 1 switches from the first stable state to the second stable state by means of controlling the ratio of lengths of the long portion to the length of the short portion, such that when the push-on-push-off bistable switch 1 is switched from the first stable state to the second stable state, displacement of the end of the bistable mechanism 12 is smaller than the second threshold value d_{BSM-th} to prevent the bistable characteristics of the bistable mechanism 12 from becoming inactive and leaving the second stable state. Further, when the push-on-push-off bistable switch 1 is switched from the second stable state to the first stable state, the displacement of the end of the bistable mechanism 12 exceeds beyond the second threshold value d_{BSM-th}, thereby ensuring the inactive of the bistable characteristics to return to the first stable state, as shown in the formula (2) below:

η·d_{DAM-snap}=d_{BSM}<d_{BSM-th} (2)

In this embodiment, the power source 14 is a single driving voltage and the thermal deformation extent of the actuator 10 is substantially in proportion to the time of applying voltage. Therefore, the push-on-push-off bistable switch 1 of the invention can accurately control displacement of the actuator 10 by controlling the time of applying voltage. That is, time to apply voltage in the process of switching from the first stable state to the second stable state is long enough, such that the displacement amplifier mechanism 13 has the sufficient output displacement to propel the bistable mechanism 12 to snap, yet without excessively applying voltage in order to prevent the displacement of bistable mechanism 12 from exceeding beyond the second threshold value ^{d}BSM-th and causing the bistable characteristics to be inactive. The bistable characteristics would be inactive due to appropriately controlling the time to apply voltage during the process of switching from the second stable state to the first stable state. Therefore, the process of switching the push-on-push-off bistable switch 1 from the second stable state to the first stable state requires a longer time of applying voltage than the process of switching from the first stable state to the second stable state.

Accordingly, the bistable switch of the invention employs only one single actuator having one driving voltage to achieve the push-on-push-off switch effect, and thus reduces complexities in the manufacture and control of the bistable switch and further reduces power consumption characteristics of the actuator.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A push-on-push-off bistable switch, including
an actuator;
a lever mechanism having a long portion, a short portion, a hinge and a fastening anchor, wherein the hinge is fixed by the fastening anchor at a connection of the long portion and the short portion, and one of the long potion and the short portion is connected to the actuator;
a bistable mechanism having one end connected to the short portion of the lever mechanism and having a first stable state and a second stable state; and
a displacement amplifier mechanism having a curving beam with one end thereof being connected to one side of the long portion of the lever mechanism opposing to the actuator, wherein the bistable mechanism and the displacement amplifier mechanism are substantially parallel to each other.

2. The push-on-push-off bistable switch of claim 1, wherein the bistable mechanism bends toward the displacement amplifier mechanism when being in the first stable state, and the bistable mechanism bends away from the displacement amplifier mechanism when being in the second stable state.

3. The push-on-push-off bistable switch of claim 1, wherein when the bistable mechanism is in the first stable state, the actuator drives the long portion or the short portion of the lever mechanism to displace so as to push one end of the displacement amplifier mechanism such that the displacement amplifier mechanism bends toward the bistable mechanism and moves laterally, and at the same time relatively moves the lever mechanism to rotate around the hinge such that the short portion of the lever mechanism pulls an end of the short portion to which the bistable mechanism is connected, and wherein when lateral displacement of the displacement amplifier mechanism exceeds beyond a gap between the displacement amplifier mechanism and the bistable mechanism, the displacement amplifier mechanism starts to propel and deform the bistable mechanism such that the bistable mechanism switches from the first stable state to the second stable state.

4. The push-on-push-off bistable switch of claim 1, wherein when the bistable mechanism is in the second stable state, the actuator actuates the long portion or the short portion of the lever mechanism to displace so as to push on one end of the displacement amplifier mechanism such that the displacement amplifier mechanism bends toward the bistable mechanism, and at the same time move the lever mechanism to rotate around the hinge such that the short portion of the lever mechanism pulls an end of the short portion to which the bistable mechanism is connected, and the bistable mechanism bends towards the displacement amplifier mechanism and becomes deformed to switch from the second stable state back to the first stable state.

5. The push-on-push-off bistable switch of claim 1, wherein the actuator is an electric thermal actuator, a static electric actuator, a piezoelectric actuator, or an electromagnetic actuator.

6. The push-on-push-off bistable switch of claim 5, wherein the electric thermal actuator comprises a first and a second anchors and a horizontal beam, wherein the horizontal beam comprises a bending portion connected to the long portion or the short portion of the lever mechanism.

7. The push-on-push-off bistable switch of claim 6, wherein the horizontal beam is constituted by a plurality of parallel V-shaped beams.

8. The push-on-push-off bistable switch of claim 1, wherein the bistable mechanism comprises a first curving beam having one end and the other end opposing to the one end, in which the one end of the first curving beam is connected to the short portion of the lever mechanism, the other end of the first curving beam has a third fastening anchor formed thereon, and the first curving beam has a first bending portion.

9. The push-on-push-off bistable switch of claim 8, wherein the first bending portion has a conducting portion extending from the first curving beam at the other end thereof corresponding to a driven portion.

10. The push-on-push-off bistable switch of claim 9, further comprising a transmission circuit having at least a pair of connecting points for insulating electrical appliances, so that when the bistable mechanism is in the second stable state, the conducting portion is connected to the connecting points for electrically conducting the transmission circuit.

11. The push-on-push-off bistable switch of claim 1, wherein the bistable mechanism is a V-beams bistable mechanism or a chevron-type bistable mechanism.

12. The push-on-push-off bistable switch of claim 8, wherein the curving beam of the displacement amplifier mechanism has a fourth fastening anchor disposed at the other end thereof corresponding to the one end connected to the long portion of the lever mechanism, and the curving beam has a bending portion that has a driving portion extending from the curving beam and disposed at one end of the bending portion facing the bistable mechanism, and wherein one end of the driving portion is adjacent to a driven portion.

13. The push-on-push-off bistable switch of claim 12, wherein the driven portion is a truss structure.

14. The push-on-push-off bistable switch of claim 1, further comprising a driving power source connected to the actuator for supplying electric power to deform the actuator so as to propel the long portion of the lever mechanism to displace.

15. The push-on-push-off bistable switch of claim 14, wherein the power source uses a single driving voltage.
